(19) United States
(12) Patent Application Publication
(10) Pub. No.: US 2019/0339170 A1
(43) Pub. Date: Nov. 7, 2019

(54) TISSUE PLANING ASSEMBLIES HAVING A VACUUM TABLE AND METHODS

(71) Applicant: Community Blood Center d.b.a Community Tissue Services, Dayton, OH (US)

(72) Inventors: Shawn Aaron Hunter, Springboro, OH (US); Robert Hoskins, Springboro, OH (US)

(73) Assignee: Community Blood Center d.b.a Community Tissue Services, Dayton, OH (US)

(21) Appl. No.: 15/968,357

(22) Filed: May 1, 2018

(51) Int. Cl. G01N 1/06

(52) U.S. Cl. CPC G01N 1/06

(57) ABSTRACT

A tissue planing assembly includes a vacuum table, a gantry system, and a cutting device. The vacuum table includes a cutting surface configured to receive a tissue sample and apply a vacuum pressure to the tissue sample. The gantry system is configured to be positioned over the cutting surface of the vacuum table and includes a blade holder. The blade holder of the gantry system is configured to be adjustable in at least a lateral direction and a longitudinal direction relative to the cutting surface of the vacuum table. The cutting device is configured to be positioned within the blade holder.

### TECHNICAL FIELD

The present specification generally relates to tissue planing assemblies and methods and, more specifically, tissue planing assemblies and methods incorporating a vacuum table.

### BACKGROUND

Skin allografts manufactured from human donor tissue are used for various medical applications. Most notably, allograft skin is used for the purpose of protecting wounds and providing a scaffold for the purpose of promoting new skin cell development and natural healing. Allograft skin consists of both the epidermis and a portion of the dermis of the donor. This is also known as split-thickness (S/T) skin. S/T skin is generally about 0.3 to about 0.65 mm thick and is somewhat difficult to obtain in sections with a surface area larger than 4 in. by 6 in. due to limitations in existing skin recovery methods.

One common method for recovering S/T skin is to use a dermatome or similar bladed instrument to remove the desired thickness directly from the donor. Another method which is commonly used is to remove sections of full-thickness (F/T) skin from the donor to recover S/T skin therefrom. F/T skin consists of the epidermis, dermis and a portion of subcutaneous fat layer and potentially muscle under the dermis. The advantage of recovering F/T skin over the direct recovery method is that the larger sections of skin can then be laid flat and processed to recover the needed S/T skin without the impediment of the donor's anatomical curves and body form. In both cases S/T skin is recovered by processing the tissue epidermis side up.

However, current methods are limited to producing S/T skin graft products with nominal widths of four inches or less based on the width of the blade used to recover the graft. The narrow strips may not be as effective in wound treatment as strips of greater size. Accordingly, a need exists for tissue planing assemblies and methods to produce skin allograft products of greater size than traditional methods.

### SUMMARY

In one embodiment, a tissue planing assembly includes a vacuum table, a gantry system, and a cutting device. The vacuum table includes a cutting surface configured to receive a tissue sample and apply a vacuum pressure to the tissue sample. The gantry system is configured to be positioned over the cutting surface of the vacuum table and includes a blade holder. The blade holder of the gantry system is configured to be adjustable in at least a lateral direction and a longitudinal direction relative to the cutting surface of the vacuum table. The cutting device is configured to be positioned within the blade holder.

In another embodiment, a method of producing a skin graft includes placing a tissue sample epidermis side down on a cutting surface of a vacuum table, applying vacuum pressure to the tissue sample through the cutting surface of the vacuum table, coupling a cutting device to a blade holder of a gantry system positioned over the cutting surface, adjusting the cutting device with the gantry system to a first predetermined cutting position, and moving the cutting device over the tissue sample to remove a first portion of a dermis of the tissue sample. The blade holder of the gantry system is adjustable in at least a lateral direction and a longitudinal direction relative to the cutting surface of the vacuum table.

In yet another embodiment, a tissue planing assembly includes a base plate, a vacuum table, a gantry system and a cutting device. The vacuum table is positioned on the base plate and includes a cutting surface. The cutting surface is configured to receive a tissue sample and apply a vacuum pressure to the tissue sample. The gantry system is coupled to the base plate and positioned over the cutting surface of the vacuum table. The gantry system includes a blade holder configured to be adjustable in at least a lateral direction and a longitudinal direction relative to the cutting surface of the vacuum table. The cutting deice is configured to be positioned within the blade holder.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a vacuum table, according to one or more embodiments shown and described herein;

FIG. 2 depicts a top view of a disassembled vacuum table, according to one or more embodiments shown and described herein;

FIG. 3 depicts a tissue planing assembly including a vacuum table, according to one or more embodiments shown and described herein;

FIG. 4 a method of producing a skin graft, according to one or more embodiments shown and described herein;

FIG. 5 depicts a partial side view of the tissue planing assembly of FIG. 3 with tissue sample disposed on the vacuum table, according to one or more embodiments show and described herein;

FIG. 6 depicts a top view of the tissue planing assembly of FIG. 5, according to one or more embodiments shown and described herein;

FIG. 7 illustrates a partial side view of the tissue planing assembly of FIG. 5 with a portion of the tissue sample having been removed by a cutting device, according to one or more embodiments shown and described herein; and

FIG. 8 illustrates a top view of the tissue planning assembly of FIG. 5, with the cutting device repositioned to continue a cutting operation, according to one or more embodiments shown and described herein.

### DETAILED DESCRIPTION

Reference will now be made in detail to various embodiments of a tissue planing apparatus. In embodiments, the tissue planing apparatus includes a vacuum table that has a cutting surface configured to receive a tissue sample. A vacuum pressure can be applied to the tissue sample through the cutting surface of the vacuum table to hold the tissue sample in place for processing. A gantry system that is positioned over the cutting surface of the vacuum table includes a blade holder that allows a cutting device to be moved over the tissue sample to remove a desired portion of the tissue sample. For example, the tissue sample can be processed epidermis side down (i.e., the epidermis of the tissue sample is facing the cutting surface of the vacuum table) such that a portion of the dermis is removed by moving the cutting device across the exposed surface of the tissue sample. Because the tissue sample is able to be processed dermis side up, the size of the resulting graft is not limited to the width of the processing blade as it is in traditional “epidermis side up” processing, discussed above.

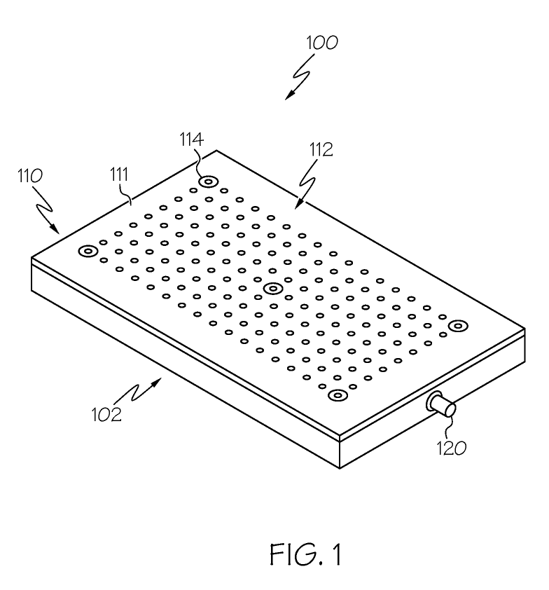

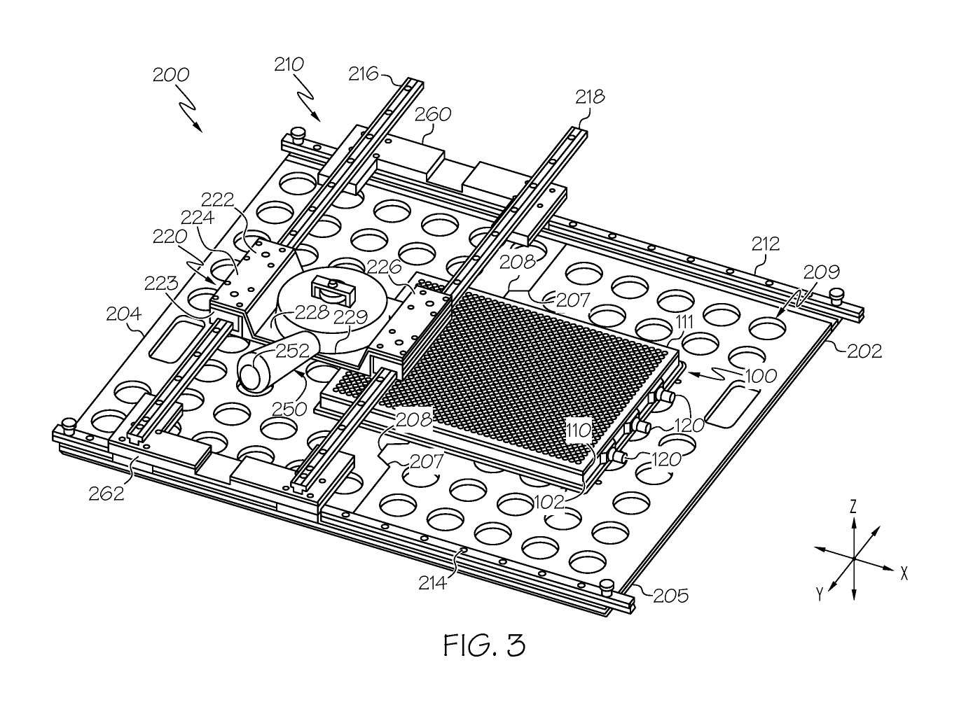

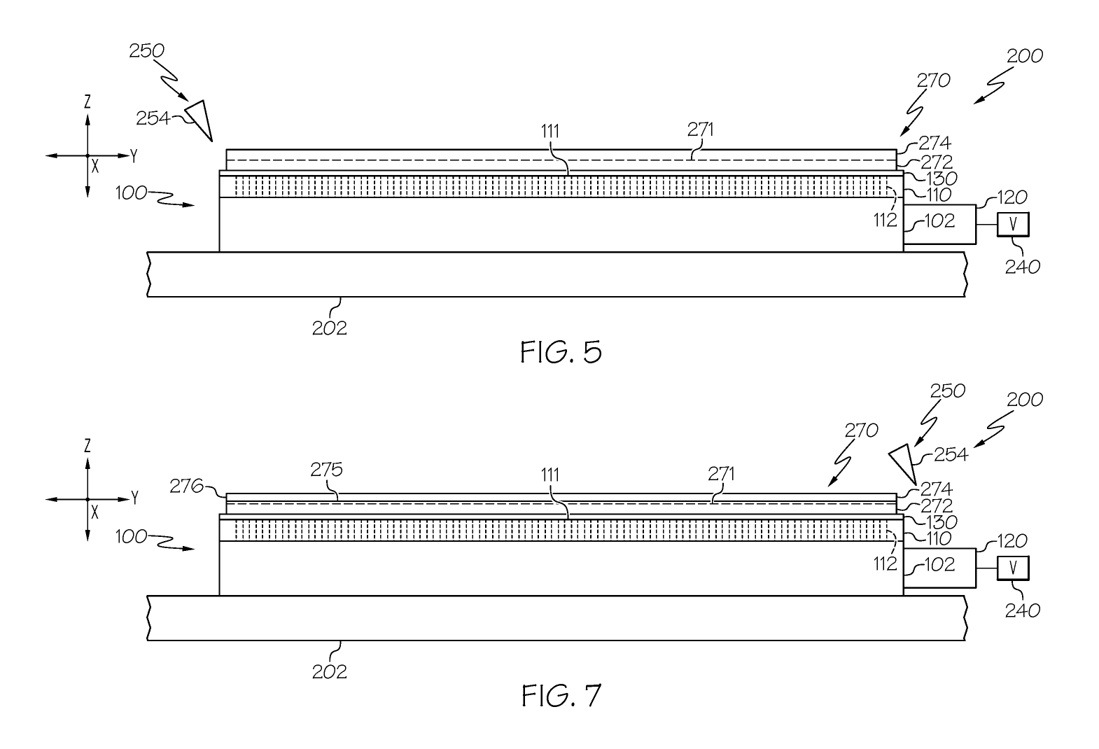

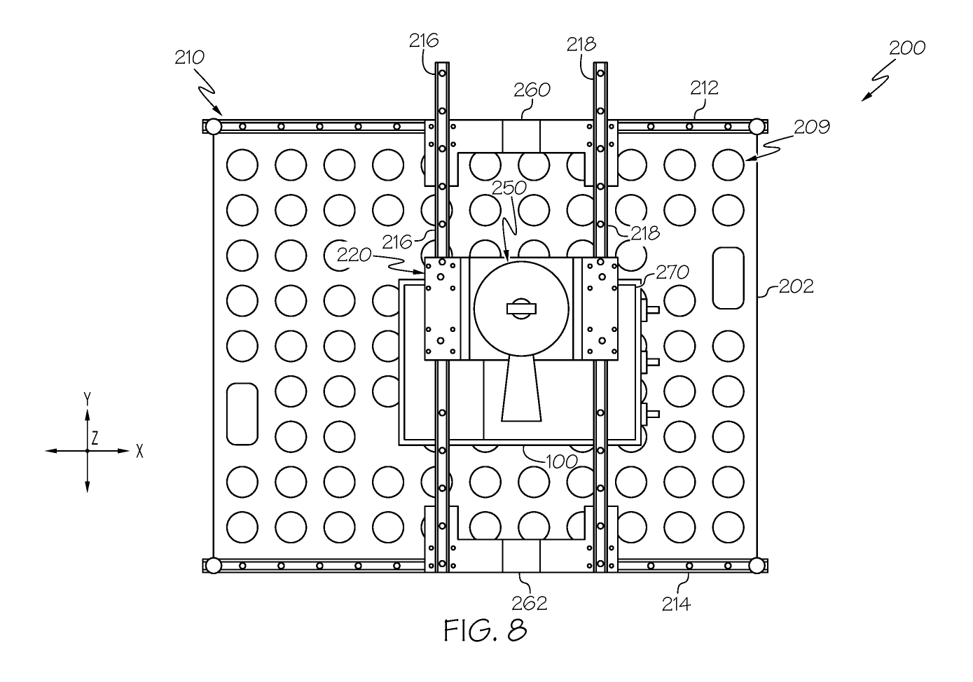

Referring now to FIG. 1, a vacuum table 100 is depicted. The vacuum table 100 includes a body portion 102 and a top plate 110 coupled to the body portion 102. The top plate 110 defines a cutting surface 111 and has a plurality of vacuum holes 112 formed therein. The vacuum table 100 further includes a vacuum source inlet 120 that can be fluidly coupled to a vacuum source (e.g., vacuum source 240 illustrated in FIGS. 5 and 7). Accordingly, when vacuum pressure is applied to the vacuum table 100 through the vacuum source inlet 120, vacuum pressure is provided through the vacuum holes 112 of the top plate 110. As will be describe in greater detail herein, the vacuum pressure provides force to hold a tissue sample (e.g., tissue sample 270 shown in FIG. 5) to the top plate 110 such that a cutting device (e.g., cutting device 250 shown in FIG. 3) can be moved across an exposed surface of the tissue sample to remove a portion of the tissue sample and plane the tissue sample to a desired thickness, such as a thickness suitable for use as a skin graft (e.g., about 0.3 mm to about 0.6 mm). It is noted that while the vacuum table 100 is illustrated as having a rectangular shape, other shapes are also contemplated such as, regular and irregular polygonal and non-polygonal shapes.

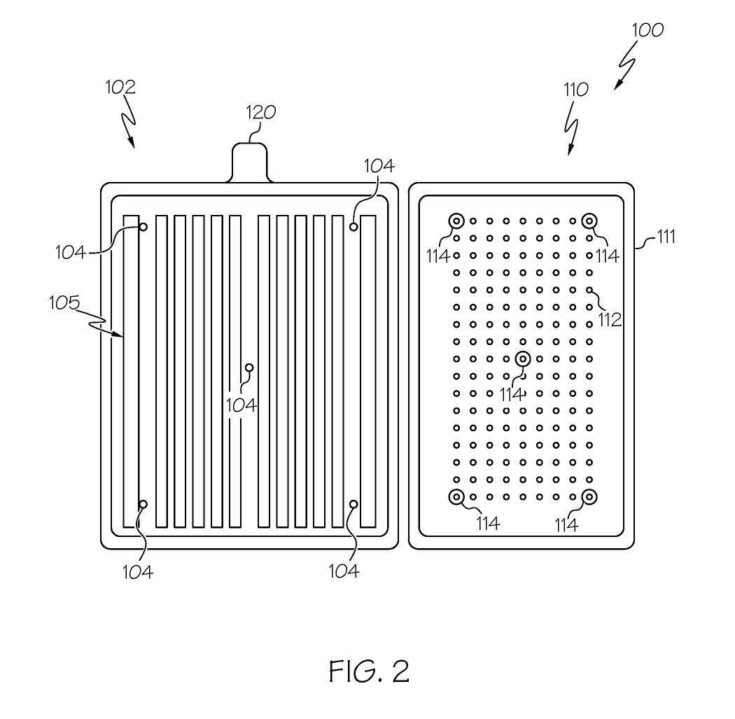

In some embodiments, the vacuum table 100 may be disassembled into component parts. For example, FIG. 2 illustrates the vacuum table 100 in a disassembled state wherein the top plate 110 is separated from the body portion 102. For example, in some embodiments, the top plate 110 may be coupled to the body portion 102 using threaded fasteners. In such embodiments, the top plate 110 includes a plurality of through-passages 114 configured to receive a fastener therethrough. The body portion 102 includes a plurality of mating apertures 104 for receiving the fastener after it has passed through the through-passage 114 of the top plate 110, wherein the fastener can thereafter be tightened within the body portion 102 to secure the top plate 110 to the body portion 102. By providing a vacuum table 100 that can be disassembled into component parts, the vacuum table 100 may be easily cleaned and sterilized prior to each use. Accordingly, both the body portion 102 and the top plate 110 may be made of any material that resists corrosion and can be sterilized repeatedly without altering structure or function. Such materials may include but are not limited to aluminum, stainless steel, polymers, composite materials, or a combination thereof.

To direct vacuum pressure from the vacuum source inlet 120 to the vacuum holes 112 of the top plate 110, the body portion 102 may provide a plurality of passageways 105 or plumbing etched or otherwise formed within the body of the body portion 102. The plurality of passageways 105 are fluidly coupled to the vacuum source inlet 120. As shown in FIG. 2, the vacuum source inlet 120 may be coupled to or formed as part of the body portion 102. In some embodiments, there may be multiple vacuum source inlets. For example, FIG. 3, which illustrates a tissue planing assembly 200, shows a vacuum table 100 with three vacuum source inlets 120 spaced along a side of the body portion 102 of the vacuum table 100. The number of vacuum source inlets 120 may be dependent on the surface area of the cutting surface 111 of the vacuum table 100. For example, a larger cutting surface 111 as provided by the top plate 110 of the vacuum table 100 may benefit from multiple vacuum source inlets 120, whereas a single vacuum source inlet 120 may be sufficient in other cases.

As noted hereinabove, the top plate 110 includes a cutting surface 111 and a plurality of vacuum holes 112 extending from the cutting surface 111 through a thickness of the top plate 110. The cutting surface 111 is configured to receive a tissue sample 270 and apply a vacuum pressure through the plurality of vacuum holes 112 to the tissue sample 270. As will be described in greater detail herein, the tissue sample 270 may be held in place by the vacuum pressure, from a vacuum source (e.g., vacuum source 240 illustrated in FIGS. 5 and 7) supplied through the top plate 110 of the vacuum table 100 so that the tissue sample 270 may be planed into a thickness useable as a skin graft (e.g., about 0.3 mm to about 0.6 mm), for example.

FIG. 5 illustrates a tissue sample 270 applied to the cutting surface 111 of the vacuum table 100. The tissue sample 270 may be a full thickness (F/T) human skin sample. However, it is contemplated that embodiments described herein can also apply to non-human tissue samples (e.g., bovine, ovine, suidae, etc.) F/T skin generally includes an epidermis layer 272 and a dermis layer 274. Attached to the dermis layer 274 may potentially be some subcutaneous fat of even some muscle tissue. The F/T skin sample is typically removed from a donor's back, upper and lower extremities, and occasionally abdomen in large sections via sharp dissection with a scalpel and/or other tissue cutting devices. The advantage of recovering F/T skin is that the larger sections of skin can be removed from the donor, laid flat, and processed without the impediment of the donor's anatomical curves and body form. Using the methodologies provided herein, large F/T skin samples may translate into larger pieces of split thickness (S/T) skin samples with a more consistent thickness. As described above, S/T skin includes the epidermis layer 272 and a portion of the dermis layer 274. Larger S/T skin can be used as skin grafts to better aid healing in patients. S/T skin is generally between about 0.3 and about 0.6 mm thick (e.g., 0.45 mm thick). One drawback of beginning with F/T skin is that it may be difficult to hold the tissue sample 270 firmly in place throughout processing. Under traditional processing techniques, a technician may need to hold the F/T skin sample with their hands while simultaneously using a cutting device to obtain the S/T skin. The vacuum table 100, as described herein, is configured to apply a vacuum pressure to the F/T skin sample so as to hold it in place for processing which may free the technician's hands. A consistent and evenly distributed vacuum pressure may hold the skin to the cutting surface 111 of the vacuum table 100 such that the F/T skin sample does not move relative to the vacuum table 100 due to the force of the cutting blade or instrument.

As noted above, under traditional S/T skin recovering techniques, cutting devices are used to directly remove the desired S/T skin from the F/T skin sample. That is, the F/T skin sample is processed epidermis side up and a cutting device is applied directly to the epidermis to remove the S/T skin. Conventional S/T skin grafts recovering techniques therefore limit the resulting S/T graft size to the cutting width of the cutting device. Using the present vacuum table 100, allows for the processing of F/T skin with the epidermis side down. This will allow technicians to use cutting devices to remove the a portion of the dermis layer including any remaining fat and/or muscle tissues fat layer from the resulting S/T skin instead of the other way around. Accordingly, by processing dermis side up, one could obtain S/T skin that is limited in size only by the area of the starting F/T skin sample.

Referring now to FIG. 3, a tissue planing assembly 200 is generally depicted. The tissue planing assembly 200 includes the vacuum table 100, according to embodiments described herein, a gantry system 210, and a cutting device 250. In some embodiments, the tissue planing assembly 200 further includes a base plate 202, wherein the vacuum table 100 is positioned on the base plate 202 during processing operations. In some embodiments, the vacuum table 100 may be coupled to the base plate 202 through any conventional coupling techniques suitable for securing the vacuum table 100 to the base plate 202 (e.g., fasteners, interlocking components, clamps, and the like). In some embodiments, the vacuum table 100 may only sit upon the base plate 202.

The base plate 202 defines a base of the tissue planing assembly 200 upon which the gantry system 210 is coupled. The base plate 202 may include a single plate or a plurality of interconnected plates. FIG. 3 illustrates the base plate 202 as including a left base plate 204 and a right base plate 205. It is noted that directional terms used herein are relative to the elements depicted in the figures and are not limiting in scope. The left base plate 204 and the right base plate 205 may interlock with one another. For example, the right base plate 205 may include a plurality of projections 207 that interlock with a plurality of indentations 208 of the left base plate 204. In some embodiments, the left base plate 204 may include a plurality of projections that interlock with a plurality of indentations in the right base plate 205.

In some embodiments, the base plate 202 may include a plurality of through apertures 209. The plurality of through apertures 209 may provide drainage of fluid or debris from the tissue sample 270 or processing materials such as saline to moisten the tissue sample 270 during processing. The base plate 202 may be made of any material suitable for use as a base. In some embodiments, the base plate 202 is made of a material that may be easily washed and sterilized (e.g., stainless steel, aluminum, and the like).

As noted above, the gantry system 210 may be coupled to the base plate 202 and allow at least longitudinal (X-direction) and lateral (Y-direction) movement of the cutting device 250 relative to the vacuum table 100. In some embodiments, the gantry system 210 may also facilitate vertical (Z-direction) movement of the cutting device 250 relative to the vacuum table 100. The gantry system 210 may include a longitudinal side rail (e.g., longitudinal side rail 212, longitudinal side rail 214) to facilitate longitudinal movement of the cutting device 250, a lateral side rail (e.g., lateral side rail 216, longitudinal side rail 212) to facilitate lateral movement of the cutting device 250, and a blade holder 220 configured to traverse the longitudinal side rail and the lateral side rail for placement of the cutting device 250 relative to the cutting surface 111 of the vacuum table 100.

For example, the gantry system 210 may include a first longitudinal side rail 212 and a second longitudinal side rail 214. The first and second longitudinal side rails 212, 214 may be coupled to the base plate 202 along longitudinal sides of the base plate 202 through any suitable means (e.g., threaded fasteners, pins, welding, brazing, and the like). The first and second longitudinal side rails 212, 214 are positioned parallel to one another across the base plate 202.

The gantry system 210 as illustrated in FIG. 3, further includes a first lateral side rail 216 and a second lateral side rail 218. The first and second lateral side rails 216, 218 may be substantially parallel to one another and may extend between the first longitudinal side rail 212 and the second longitudinal side rail 214. The first and second lateral side rails 216, 218 may be engaged with the longitudinal side rails 212, 214 such that the first and second lateral side rails 216, 218 are able to traverse the length of the longitudinal side rails 212, 214. For example, a first carriage 260 is configured to slidingly couple one end of the first and second lateral side rails 216, 218 to the first longitudinal side rail 212 and a second carriage 262 is configured to slidingly coupled a second end of the first and second lateral side rails 216, 218 to the second longitudinal side rail 214. The first and second lateral side 216, 218 rails may be coupled to the first and second carriages so that a distance between the first and second lateral side rails 216, 218 remain constant.

The blade holder 220 may include an attachment plate 222 and a holder carriage 223 which slidingly couples the attachment plate 222 to the first and second lateral side rails 216, 218. For example, the attachment plate 222 may include a first coupling wing 224 coupled to the holder carriage 223, a second coupling wing 226 coupled to the holder carriage 223, and a receiving surface 228 vertically spaced from the first and second coupling wings 224, 226 in the Z-direction. That is the receiving surface 228 may be spaced below the first and second coupling wings. 224, 226 The receiving surface 228 may have a cutting device port 229 for receiving a cutting device 250 (e.g., cutting device 250) and allowing a blade of the cutting device 250 to extend vertically beneath the attachment plate 222 such that a cutting operation can be performed by the cutting device 250.

The first and second coupling wings 224, 226 can be adjustably coupled to the holder carriages. For example, the vertical position of the attachment plate 222 in the z-direction may be adjusted by controlling the spacing between the first and second wings 224, 226 with a top surface of the holder carriage 223. In some embodiments, such adjustment may be done by placing a spacer (not shown) in between the first and second coupling wings 224, 226 of the attachment plate 222 and the top surface of the holder carriage 223. Threaded fasteners or other suitable fastening elements may then couple the first and second wings of the attachment plate 222 and the first and second holder carriages. The attachment plate 222 may be made from any material that may be easily washed and sterilized (e.g., stainless steel, aluminum, and the like).

The cutting device 250 may be any device capable of removing a layer from a tissue sample. For example, a commercially available Amalgatome, Dermatome, or the like may be a suitable cutting device. Other cutting devices may include, but are not limited to non-motorized cutting blades, straight blades, multiple blades, spiral configuration blades, laser cutting devices, ultrasonic cutting devices, or any other physical and/or energy source methods of cutting. The cutting device 250 may include a handle 252 which may allow a user to more easily position the cutting device 250 within the gantry system 210 and a blade 254, such as illustrated in FIG. 5. In some embodiments, the cutting device 250 itself may be adjustable in the vertical (z) direction. For example, the cutting device 250 may be capable of lowering or lifting the blade 254 to adjust of the cutting device 250.

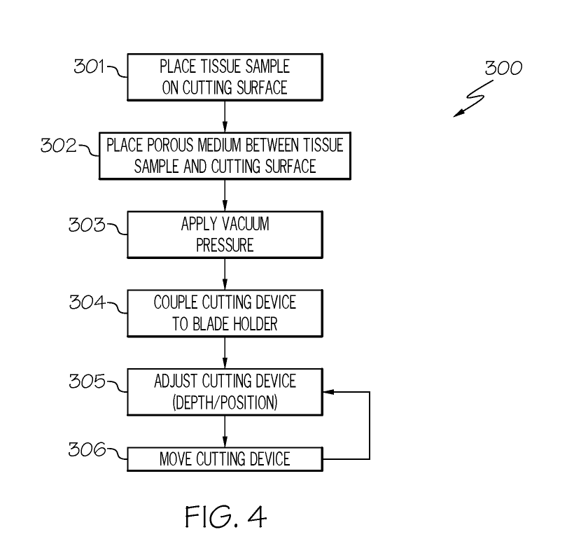

FIG. 4 illustrates an exemplary method 300 for producing a skin graft using the vacuum table 100 and gantry system 210 described herein. It is noted that though the steps of the method 300 are shown as having a particular order, the steps may be done in a different order and/or with a fewer or greater number of steps. The method 300 includes placing a tissue sample 270 (such as tissue sample 270 illustrated in FIG. 5) on to the cutting surface 111 of the vacuum table 100 (block 301).

Referring also to FIG. 5, a side view of a portion of the tissue planing assembly 200 is generally illustrated. The tissue sample 270 is positioned above the cutting surface 111 of the vacuum table 100. In some embodiments, the tissue sample 270 is placed in direct contact with the cutting surface 111 of the vacuum table 100. In other embodiments, a porous medium 130 may be positioned between the tissue sample 270 and the cutting surface 111 of the vacuum table 100 (block 302).

The tissue sample 270 illustrated in FIG. 5 is an F/T tissue sample 270. Accordingly the tissue sample 270 includes an epidermis layer 272 and a dermis layer 274. The transition 271 between the epidermis layer 272 and the dermis layer 274 is generally indicated by dashed line 271. However, it should be understood that thickness of the layers of the tissue sample 270 and the components of the tissue planing assembly 200 are exaggerated for convenience and ease of understanding. In some embodiments, and as illustrated in FIG. 5, the epidermis layer 272 is directed toward the cutting surface 111 of the vacuum table 100 and the dermis layer 274 faces an upward direction and is exposed for processing. As noted above, the dermis layer 274 may also include additional tissue such as subcutaneous fat and/or muscle tissue (e.g., an adipose layer). In other embodiments, the dermis layer 274 may be directed toward the cutting surface 111 such that the epidermis layer 272 is exposed for direct processing. In yet further embodiments, the adipose layer may be removed prior to directing the dermis layer 274 toward the cutting surface 111 of the vacuum table 110.

As noted above, in some embodiments, the tissue sample 270 is placed in direct contact with the cutting surface 111 of the vacuum table 100 (block 303 FIG. 4). In such cases, the plurality of vacuum holes 112, shown in phantom, comprise a diameter of less than about 5.0 mm. For example, the diameter may be between about 1 mm to about 2 mm. During experimentation, it was found that when a tissue sample 270 is in direct contact with the cutting surface 111 diameters of larger than about 5 mm may allow soft tissue and fluid to be pulled down into the top plate 110 through the vacuum holes 112. Such may make it difficult to manufacture a skin graft with a uniformed thickness or may cause plastic deformation of the tissue sample 270. Diameters of less than 1 mm may not allow enough surface area contact with the tissue sample 270, resulting in a low holding force between the cutting surface 111 and the tissue sample 270.

As noted above, in some embodiments, a porous medium 130 may be disposed between the tissue sample 270 and the cutting surface 111 of the vacuum table 100. Use of porous medium 130 between the cutting surface 111 and the tissue sample 270 allows for the use of vacuum holes 112 with a larger diameter of up to about 13 mm. In some embodiments, use of the porous medium 130 between the cutting surface 111 and the tissue sample 270 may allow for use of vacuum holes 112 with smaller diameters of less than or equal to about 2 mm (e.g., diameters of between about 1 mm and about 0.01 mm). The porous medium 130 may also allow for a greater frictional force (F_{f}) by way of providing a greater coefficient of friction (μ) between the tissue sample 270 and the cutting surface 111. This principle can be demonstrated by the equation:

F_{f}=μN

where F_{f} is the resulting frictional force of the normal force (N) supplied by the vacuum pressure and coefficient of friction (μ) between the vacuum table 100 and skin/tissue interface. In some embodiments, the porous medium 130 has a coefficient of friction (μ) larger than that of the cutting surface 111. The porous medium 130 may be any porous material such as, for example, foam (e.g., 1 mm thick black foam), mesh (e.g., polypropylene mesh), cloth, netting, or any combination thereof.

Referring again to FIG. 4, the method 300 further includes applying vacuum pressure through the cutting surface 111 of the vacuum table 100 (block 303). As illustrated in FIG. 5, the vacuum table 100 is fluidly coupled to a vacuum source 240, such as a vacuum pump for example. Evacuating air from a closed volume develops a pressure differential between the volume and the surrounding atmosphere. If this closed volume is bound by the surface of a vacuum cup/seal (skin sample) and a workpiece (vacuum table), the atmospheric pressure will press the two objects together. The amount of holding force depends on the surface area shared by the two objects and the vacuum level. In most mechanical vacuum systems, a vacuum pump or generator removes air from a system to create the pressure differential. A perfect vacuum is defined as the complete removal of all air molecules from a container, however this state of perfect vacuum cannot be achieved. Achievable maximum vacuum pressure is dependent on several variables. However, the maximum achievable vacuum pressure is primarily dependent on the atmospheric pressure and the means by which matter (e.g., air mass) is removed from a space with fixed volume or pump design as well as the surface area contact between the two objects. In general, as altitude increases the atmospheric air pressure decreases, which lowers the maximum achievable vacuum pressure level. The opposite is true as altitude decreases. Gauge vacuum pressure is the additional removal of pressure in a system relative to atmospheric pressure. It is a convenient vacuum pressure measurement for most practical applications. A standard unit for gauge pressure can be reported in “Inches of Mercury” or in-Hg. Typical gauge vacuum pressure is in the range of 0 to 29 inHg.

As a result of early exploration into the effects of vacuum pressure on F/T skin samples and the resulting frictional force (F_{f}), gauge vacuum pressure in the medium to high range (e.g., 3 to 20 inHg) is appropriate to apply to F/T tissue samples and/or other tissues. The effect on the tissue may be dependent on what material is used in between the cutting surface 111 of the vacuum table 100 (if any at all) and the size of the plurality of vacuum holes 112 in contact with the tissue. In general, if the porous medium 130 (e.g., foam, cloth, netting, etc.) is used between the F/T tissue sample 270 and the cutting surface 111 of the vacuum table 100, gauge vacuum pressures of up to about 25 inHg can be used without damaging (e.g., plastically deforming) the tissue sample 270 when holes of up to 5 mm in diameter are used. If no porous medium 130 is used between the cutting surface 111 and the tissue sample 270, it has been found that a gauge vacuum pressure of about 10 inHg may be used for vacuum holes 112 having a 5 mm diameter. As the vacuum hole diameter decreases, the gauge vacuum pressure can be increased such that the tissue is not pulled into the holes. In some embodiments, vacuum hole diameters of about 1.5 mm to about 2 mm and a gauge pressure of 24 inHg may be used for processing F/T tissue samples.

It is noted that in some embodiments, the vacuum table 100 is also configured to selectively provide positive pressure to the cutting surface 111 of the vacuum table 100. For example, the vacuum source 240 fluidly coupled to the vacuum inlet 120 can be “reversed” such that positive pressure is pushed through the plurality of holes. Positive pressure may allow the tissue sample 270 to be more easily removed from the vacuum table 100 after processing.

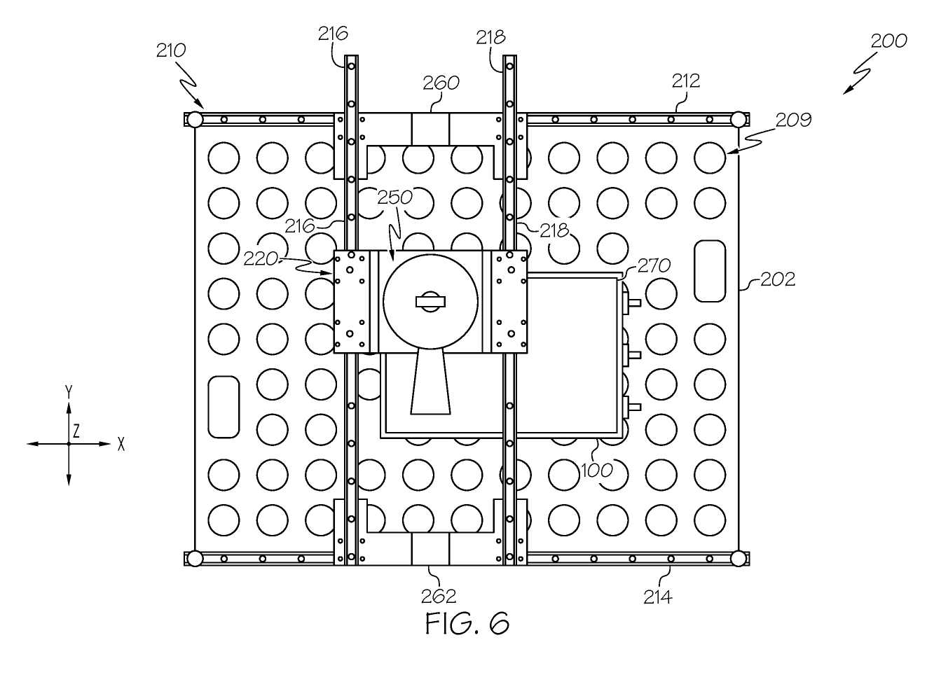

Referring again to FIG. 4, the method 300 further includes coupling a cutting device 250 to the blade holder 220 of the gantry system 210 (block 304). As noted above, the cutting device 250 can be any conventional cutting device 250 suitable for debriding a portion of the dermis layer 274 from the tissue sample 270. The method 300 further includes adjusting the cutting device 250 with the gantry system 210 to a first predetermined cutting position (block 305). Adjustment of the cutting device 250 may include adjustment in the lateral direction (Y), longitudinal direction (X), and/or the vertical direction (Z). Referring also to FIGS. 5 and 6, the cutting device 250 is shown positioned in a first position wherein the cutting device 250 is ready to perform a cutting operation on the tissue sample 270. Though the first position is generally illustrated as being in a top left hand corner of the vacuum table 100, the first position could be any position. The cutting device 250 can be moved over the tissue sample 270 to remove a first portion of a dermis layer 274 of the tissue sample 270. For example, the cutting device 250 may be moved laterally (in the Y-direction) across the tissue sample 270. However, other directions of cutting could also be used.

FIG. 7 illustrates a portion of the dermis layer 274 of the tissue sample 270 having been removed above cut line 275. That is the cutting device 250 has removed a first portion 276 of the dermis layer 274 to a cutting depth indicated at cut line 275. After removing the first portion of the tissue sample 270, the cutting device 250 can be readjusted with the gantry system 210 and moved to a second predetermined cutting position (blocks 305 and 306 of method 300 illustrated in FIG. 4). The second predetermined cutting position may be laterally spaced from the first predetermined cutting position. The cutting device 250 may then be moved over the tissue sample 270 to remove a second portion of the dermis portion of the tissue sample 270. Additional portions of the dermis layer 274 may be removed until the tissue sample 270 has the desired thickness and consistency. It is noted that FIGS. 6 and 8, illustrate the tissue sample 270 as extending near to an outside perimeter of the vacuum table 100. However, the tissue sample 270 may be larger or smaller. For example, in cases the tissue sample 270 may extend to or over the edges of the vacuum table. The resulting S/T skin graft may have a thickness of between about 0.3 mm to about 0.6 mm wherein only a portion of the dermis layer 274 remains while the whole of the epidermis 272 is untouched.

It is noted that in some embodiments, the vacuum table 100 may be used in conjunction with other holding tools to hold the tissue sample 270 in place. For example, edges of the tissue sample 270 may be held down with magnets or clamping devices.

In yet further embodiments, the gantry system 210 and cutting device 250 may be motorized and controlled with a control system (e.g., a microcontroller) operable to control the gantry system 210 to move the blade holder 220 to perform a cutting operation with the cutting device 250. Accordingly, the gantry system 210 and cutting device 250 may be controlled substantially hands-free and/or from a remote location.

It should now be understood that embodiments disclosed herein are directed to the tissue planing assemblies that include a vacuum table that has a cutting surface configured to receive a tissue sample and methods. A vacuum pressure can be applied to the tissue sample through the cutting surface of the vacuum table to hold the tissue sample in place for processing. A gantry system that is positioned over the cutting surface of the vacuum table includes a blade holder that allows a cutting device to be moved over the tissue sample to remove a desired portion of the tissue sample. In such embodiments, the tissue sample is able to be processed epidermis side down such that a portion of the dermis is removed by moving the cutting device across the exposed surface of the tissue sample. Because the tissue sample is able to be processed dermis side up, the size of the resulting graft is not limited to the width of the processing blade as it is in traditional “epidermis side up” processing.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tissue planing assembly comprising:
a vacuum table comprising a cutting surface, wherein the cutting surface is configured to receive a tissue sample and apply a vacuum pressure to the tissue sample;
a gantry system configured to be positioned over the cutting surface of the vacuum table and comprising a blade holder, wherein the blade holder of the gantry system is configured to be adjustable in at least a lateral direction and a longitudinal direction relative to the cutting surface of the vacuum table; and
a cutting device configured to be positioned within the blade holder.

2. The tissue planing assembly of claim 1, wherein the blade holder of the gantry system is further adjustable in a vertical direction relative to the cutting surface of the vacuum table.

3. The tissue planing assembly of claim 1, wherein the cutting surface of the vacuum table comprises a plurality of vacuum holes for providing the vacuum pressure to the tissue sample, wherein the plurality of vacuum holes comprise a diameter of about 1.0 mm to about 13.0 mm.

4. The tissue planing assembly of claim 1, further comprising a porous medium configured to be positioned between the tissue sample and the cutting surface of the vacuum table.

5. The tissue planing assembly of claim 1, wherein the vacuum table further comprises:
a body portion; and
a top plate that comprises the cutting surface and is disassemblable from the body portion.

6. The tissue planing assembly of claim 1, wherein the vacuum table is configured to selectively provide positive pressure to the cutting surface of the vacuum table.

7. The tissue planing assembly of claim 1, further comprising a control system operable to control the gantry system to move the blade holder to perform a cutting operation with the cutting device.

8. A method of producing a skin graft, comprising:
placing a tissue sample epidermis side down on a cutting surface of a vacuum table;
applying vacuum pressure to the tissue sample through the cutting surface of the vacuum table;
coupling a cutting device to a blade holder of a gantry system positioned over the cutting surface, wherein the blade holder of the gantry system is adjustable in at least a lateral direction and a longitudinal direction relative to the cutting surface of the vacuum table;
adjusting the cutting device with the gantry system to a first predetermined cutting position; and
moving the cutting device over the tissue sample to remove a first portion of a dermis of the tissue sample.

9. The method of claim 8, further comprising:
readjusting the cutting device with the gantry system to a second predetermined cutting position, laterally spaced from the first predetermined cutting position; and
moving the cutting device over the tissue sample to remove a second portion of the dermis of the tissue sample.

10. The method of claim 8, further comprising adjusting a cutting depth of the cutting device with the gantry system.

11. The method of claim 8, further comprising placing a porous medium between the tissue sample and the cutting surface of the vacuum table.

12. The method of claim 8, wherein the cutting surface of the vacuum table comprises a plurality of vacuum holes for providing the vacuum pressure to the tissue sample, wherein the plurality of vacuum holes comprise a diameter of up to about 13.0 mm.

13. The method of claim 8, further comprising applying a positive pressure to the cutting surface of the vacuum table and removing the tissue sample from the vacuum table.

14. A tissue planing assembly comprising:
a base plate;
a vacuum table positioned on the base plate and comprising a cutting surface, wherein the cutting surface is configured to receive a tissue sample and apply a vacuum pressure to the tissue sample;
a gantry system coupled to the base plate and positioned over the cutting surface of the vacuum table and comprising a blade holder, wherein the blade holder of the gantry system is configured to be adjustable in at least a lateral direction and a longitudinal direction relative to the cutting surface of the vacuum table; and
a cutting device configured to be positioned within the blade holder.

15. The tissue planing assembly of claim 14, wherein the base plate comprises a plurality of through holes.

16. The tissue planing assembly of claim 14, wherein the gantry system comprises:
a lateral side rail extending laterally across the base plate to facilitate lateral movement of the blade holder; and
a longitudinal side rail extending longitudinally across the base plate to facilitate longitudinal movement of the blade holder.

17. The tissue planing assembly of claim 14, wherein the blade holder of the gantry system is further adjustable in a vertical direction relative to the cutting surface of the vacuum table.

18. The tissue planing assembly of claim 14, wherein the cutting surface of the vacuum table comprises a plurality of vacuum holes for the provision of the vacuum pressure to the tissue sample, wherein the plurality of vacuum holes comprise a diameter of up to about 13.0 mm.

19. The tissue planing assembly of claim 1, further comprising a porous medium positioned between the tissue sample and the cutting surface of the vacuum table.

20. The tissue planing assembly of claim 15, wherein the vacuum table further comprises:
a body portion; and
a top plate that comprises the cutting surface and is disassemblable from the body portion.
